(19) United States
(12) Patent Application Publication
(10) Pub. No.: US 2025/0206128 A1
(43) Pub. Date: Jun. 26, 2025

(54) VEHICLE

(71) Applicant: MAZDA MOTOR CORPORATION, Hiroshima (JP)

(72) Inventor: Toshio SAKAMOTO, Utsunomiya City (JP)

(73) Assignee: MAZDA MOTOR CORPORATION, Hiroshima (JP)

(21) Appl. No.: 18/945,055

(22) Filed: Nov. 12, 2024

(30) Foreign Application Priority Data
Dec. 22, 2023 (JP) 2023-216780

(51) Int. Cl. B60K 11/08

(52) U.S. Cl. CPC B60K 11/085

(57) ABSTRACT

A vehicle of the present invention comprises a heat exchanger provided at a front part of the vehicle, an opening portion provided in front of the heat exchanger and to introduce traveling air therethrough to a vehicle rear side, and a foreign-object-removal opening portion provided below the opening portion and to discharge and remove a foreign object therethrough to a vehicle outside, wherein an opening-closing valve is provided at the foreign-object removal opening portion, a grille shutter is provided at the opening portion, the grille shutter and the opening-closing valve are linked by a linkage member such that the both devices are movable synchronously, and an actuator to drive the grille shutter and the opening-closing valve is provided.

### BACKGROUND OF THE INVENTION

The present invention relates to a vehicle comprising a heat exchanger provided at a front part of the vehicle, a first opening portion provided in front of the heat exchanger and to introduce traveling air therethrough to a vehicle rear side, and a second opening portion provided below the first opening portion and to discharge and remove a foreign object therethrough to a vehicle outside.

Conventionally, a so-called radiator provided at the front part of the vehicle comprises a so-called grille shutter to control a flow-in amount of the traveling air, which is introduced through a front grille, a lower duct, and the like, to the radiator. Herein, Japanese Patent Laid-Open Publication No. 2014-198507 discloses a vehicle which comprises a recess portion for draining and a drain hole (foreign-object removal hole), which perform to remove foreign objects, such as rainwater or small stones which have flowed in through the grille shutter.

In the vehicle disclosed in the above-described patent document, however, since the foreign-object removal hole is always open to the outside, the traveling air flows in this hole all the times even when there is a situation where the rainwater or the small stones do not flow in. Accordingly, flowing of the traveling air may be disturbed by a turbulence which is generated when the traveling air passes through the foreign-object removal hole, so that the air resistance of the vehicle may improperly increase. This increase of the air resistance generally causes a problem for the vehicle. In particular, this has recently become a serious problem for the vehicle which is provided with a heavy object of a battery (especially, for an electric vehicle) and expected to have a long cruising distance.

### SUMMARY OF THE INVENTION

The present invention has been devised in view of the above-described matters, and an object of the present invention is to provide a vehicle which can properly remove the foreign object, suppressing the turbulence of the traveling air and thereby reducing the traveling resistance.

The present invention is a vehicle which comprises a heat exchanger provided at a front part of the vehicle, a first opening portion provided in front of the heat exchanger and to introduce traveling air therethrough to a vehicle rear side, and a second opening portion provided below the first opening portion and to discharge and remove a foreign object therethrough to a vehicle outside, wherein an opening-closing device to open and close the second opening portion is provided at the second opening portion.

According to this invention, since the second opening portion for discharging and removing the foreign object therethrough to the vehicle outside is provided in front of the heat exchanger and below the first opening portion and also the opening-closing device to open and close the second opening portion is provided, by opening or closing the second opening portion according to a degree of the traveling resistance (particularly, the air resistance), the foreign object can be removed properly, suppressing the turbulence of the traveling air and thereby reducing the traveling resistance. That is, the traveling resistance can be reduced properly by closing the second opening portion when the traveling resistance of the vehicle is large (e.g., the vehicle travels at a high vehicle-speed). Meanwhile, when the traveling resistance is small (e.g., the vehicle travels at a low vehicle-speed), the foreign object can be removed properly by opening the second opening portion.

In the present invention, it is preferable that a frame member to form the first opening portion is provided, the second opening portion is formed at a lower part of the frame member, and the lower part of the frame member has an inclination portion which is configured to be downward inclined toward the second opening portion in an elevational view.

According to this structure, since the inclination portion configured to be downward inclined toward the second opening portion is provided at the lower part of the frame member, the foreign objects tend to gather at the second opening portion, so that the foreign objects which have come in from a vehicle front side, for example, can be removed more effectively.

In the present invention, it is preferable that the second opening portion and the opening-closing device constitute a foreign-object removal device, which is provided at a central portion of the lower part of the frame member in the elevational view.

According to this structure, since the second opening portion and the opening-closing device as the foreign-object removal device are provided at the central portion of the lower part of the frame member, the foreign object can be removed more effectively by providing the foreign-object removal device at a lateral-symmetrical position.

In the present invention, it is preferable that another opening-closing device to open and close the first opening portion is provided at the first opening portion, and the both opening-closing devices are linked by a linkage member such that the both devices are movable synchronously.

According to this structure, since the both opening-closing devices can be moved (operated) synchronously by means of the linkage member, deterioration of the traveling resistance due to the driving delay can be prevented. That is, when the first opening portion is closed by the opening-closing device for the first opening portion and thereby the traveling resistance (air resistance) caused by the traveling air flowing in the heat exchanger is reduced, the second opening portion is closed at the same time by driving the opening-closing device for the second opening portion concurrently with the function of the linkage member, so that the traveling resistance (air resistance) caused by the traveling air flowing in the second opening portion can be reduced.

In the present invention, it is preferable that the first opening portion is a grille opening portion which is provided on a front-face side of the heat exchanger and introduces the traveling air therethrough to the heat exchanger, the opening-closing device for the first opening portion is a grille-shutter device comprising a grille shutter operative to open and close the grille opening portion, an actuator to drive the grille shutter is connected to the grille-shutter device, the opening-closing device for the second opening portion comprises an opening-closing valve operative to open and close the second opening portion, and the linkage member interconnects the grille shutter and the opening-closing valve such that when the grille shutter is closed by the actuator, the opening-closing valve is closed.

According to this structure, when the first opening portion (grille opening portion) is closed by driving the grille shutter by means of the actuator for reduction of the traveling resistance (air resistance) due to the traveling air flowing in the heat exchanger, the traveling resistance (air resistance) due to the traveling air flowing in the second opening portion can be concurrently reduced by closing the opening-closing valve of the second opening portion with the function of the linkage member. Accordingly, the first opening portion (grille opening portion) and the second opening portions are made in a closed state at the same time, thereby reducing the vehicle resistance more securely.

In the present invention, it is preferable that the vehicle further comprises another opening-closing device to open and close the first opening portion, an actuator to drive the opening-closing device for the first opening portion and the opening-closing device for the second opening portion, a vehicle-speed sensor to detect a speed of the vehicle, and a control device to control the actuator according to the vehicle speed detected by the vehicle-speed sensor, wherein the control device is configured such that when the detected vehicle speed is a specified speed or more, both the opening-closing devices are driven to close both the opening portions, and when the detected vehicle speed is less than the specified speed, both the opening-closing devices are driven to open both the opening portions.

According to this structure, when the detected vehicle speed is the specified speed or more and therefore it is considered that the traveling resistance is relatively large, the actuator is driven such that the first opening portion and the second opening portion are closed together, thereby reducing the traveling resistance effectively. Meanwhile, when the detected vehicle speed is less than the specified speed and thereby it is considered that the traveling resistance is relatively small, the actuator is driven such that the first opening portion and the second opening portion are opened together, thereby removing the foreign object effectively.

In the present invention, it is preferable that the vehicle further comprises a linkage member to interconnect both the opening-closing devices such that the both devices are movable synchronously, wherein the actuator drives the opening-closing device for the first opening portion, and the opening-closing device for the second opening portion is driven synchronously with the opening-closing device for the first opening portion driven by the actuator by means of the linkage member.

According to this structure, since the opening-closing device for the second opening portion and the opening-closing device for the first opening portion are driven synchronously by means of the linkage member, deterioration of the traveling resistance due to the driving delay can be prevented. That is, when the first opening portion is closed by the actuator driving the opening-closing device for the first opening portion and thereby the traveling resistance (air resistance) caused by the traveling air flowing in the heat exchanger is reduced, the opening-closing device for the second opening portion is driven at the same time by the function of the linkage member and thereby the second opening is closed at the same time, so that the traveling resistance (air resistance) due to the traveling air flowing in the second opening portion can be reduced.

In the present invention, it is preferable that the first opening portion is a grille opening portion which is provided on a front-face side of the heat exchanger and introduces the traveling air therethrough to the heat exchanger, the opening-closing device for the first opening portion is a grille-shutter device comprising a grille shutter operative to open and close the grille opening portion, the actuator drives the grille shutter of the grille shutter device, and the opening-closing device for the second opening portion is driven according to opening and closing of the grille shutter such that when the grille shutter is closed, the opening-closing device for the second opening portion is closed, and when the grille shutter is opened, the opening-closing device for the second opening portion is opened.

According to this structure, when the first opening portion (grille opening portion) is closed by driving the grille shutter by means of the actuator for the reduction of the traveling resistance (air resistance) due to the traveling air flowing in the heat exchanger, the traveling resistance (air resistance) due to the traveling air flowing in the second opening portion can be reduced by closing the opening-closing valve of the second opening portion concurrently. Accordingly, the first opening portion (grille opening portion) and the second opening portions are made in a closed state at the same time, thereby reducing the vehicle resistance more securely.

In the present invention, it is preferable that the opening-closing device for the second opening portion comprises an opening-closing valve operative to open and close the second opening portion, and the vehicle further comprises a linkage member to interconnect the grille shutter and the opening-closing valve such that when the grille shutter is closed by the actuator, opening-closing of the opening-closing valve is synchronized with opening-closing of the grille shutter.

According to this structure, when the first opening portion (grille opening portion) is closed by driving the grille shutter by means of the actuator for the reduction of the traveling resistance (air resistance) due to the traveling air flowing in the heat exchanger, the traveling resistance (air resistance) due to the traveling air flowing in the second opening portion can be reduced by concurrently closing the opening-closing valve of the second opening portion with the function of the linkage member. Accordingly, the first opening portion (grille opening portion) and the second opening portions are made in the closed state at the same time, thereby reducing the vehicle resistance more securely.

Thus, the vehicle of the present invention can properly remove the foreign object, suppressing the turbulence of the traveling air and thereby reducing the traveling resistance.

The present invention will become apparent from the following description which refers to the accompanying drawings.

### BRIEF DESCRIPTION OF THE DRAWINGS

FIG. 1 is a side view showing a schematic structure of a vehicle according to an embodiment of the present invention.

FIG. 2 is a partially-sectional left-side view of a grille shutter device, a foreign-object removal device, and a front grille of the vehicle according to the embodiment of the present invention, showing an open state of the grille shutter device and the foreign-object removal device.

FIG. 3 is a perspective view of the grille shutter device and the foreign-object removal device according to the present embodiment, when viewed from a vehicle front-left side, showing a closed state of these devices.

FIG. 4 is an elevational view of the grille shutter device and the foreign-object removal device according to the present embodiment, when viewed from a vehicle front side, showing the closed state of these devices.

FIG. 5 is an elevational view explaining respective main parts of the grille shutter device and the foreign-object removal device according to the present embodiment, showing the closed state of these devices.

FIG. 6 is an elevational view explaining the respective main parts of the grille shutter device and the foreign-object removal device according to the present embodiment, showing the open state of these devices.

FIG. 7 is a side view explaining a schematic structure of a linkage device of the grille shutter device and the foreign-object removal device according to the present embodiment, when viewed from a vehicle left side.

FIG. 8 is a partially-sectional perspective view of the grille shutter device and the foreign-object removal device according to the present embodiment, when viewed from the vehicle front-left side, explaining the function of these devices in the open state.

FIG. 9 is a partially-sectional perspective view of the grille shutter device and the foreign-object removal device according to the present embodiment, when viewed from the vehicle front-left side, explaining the function of these devices in the closed state.

FIG. 10 is a block diagram showing a schematic structure of a control device of the vehicle according to the present embodiment.

FIG. 11 is a flowchart showing control contents executed by the control device of the vehicle according to the present embodiment.

### DETAILED DESCRIPTION OF THE INVENTION

Hereafter, a vehicle according to an embodiment of the present invention will be described referring to the accompanying drawings.

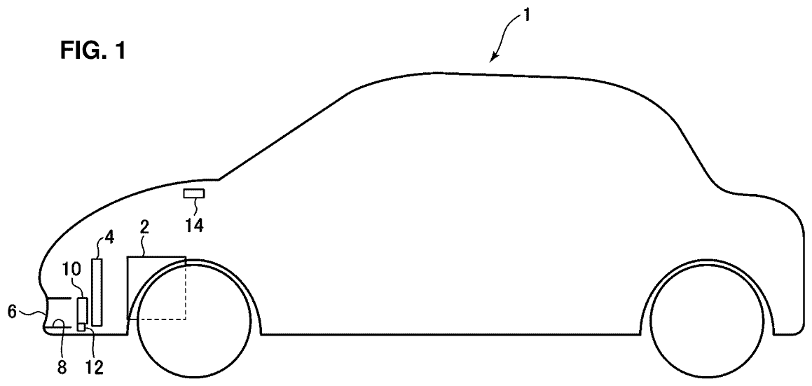

First, a whole structure of a vehicle according to the embodiment of the present invention will be described referring to FIG. 1. FIG. 1 is a side view showing a schematic structure of a vehicle according to the embodiment of the present invention. As shown in FIG. 1, a vehicle 1 is a so-called electric automobile provided with a motor 2 as a power source. The vehicle 1 comprises a radiator (heat exchanger) 4 to conduct heat exchanging between a colorant circulating in the motor 2 and the like and traveling air in order to cool the motor 2 and batteries, not illustrated, and the radiator 4 is configured such that the traveling air is introduced thereto by way of a front grille 6 provided at a vehicle front-end portion, a lower duct 8 provided below the vehicle front-end portion, and the like.

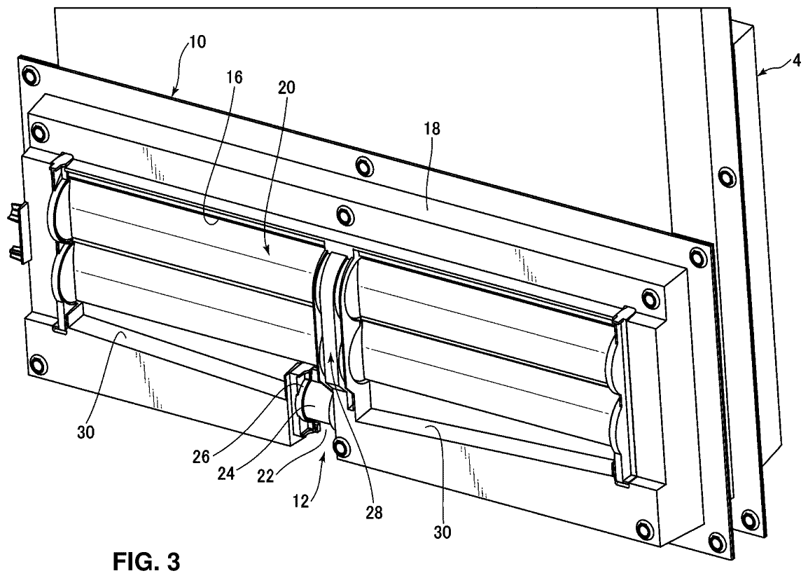

Further, a grille shutter device 10 is provided in front of and adjacently to the above-described radiator 4. The grill shutter device 10 is configured to close a grille shutter 20 (see FIG. 3) provided in a grille opening portion 16, described later, and thereby reduce the traveling resistance as the air resistance so as to improve the fuel efficiency or to open the grille shutter 20 and thereby introduce the traveling air to the radiator 4 so as to improve the cooling effects of the radiator 4.

Moreover, a foreign-object removal device 12 to remove foreign objects, such as rainwater or small stones, which have flowed in mainly through the grille shutter 6 or the lower duct 8 is provided on a vehicle lower side of the grille shutter device 10. The foreign-object removal device 12 discharges and removes the foreign objects to a vehicle outside through a foreign-object hole 22, described later, for their removal.

Also, the vehicle 1 is provided with a controller (control device) 14 to control opening-closing operations of the grille shutter device 10 and the foreign-object removal device 12. The controller 14 is constituted by a computer which comprises a processing device (circuit) as a processor (CPU), memories (ROM, RAM) to store various kinds of program, interfaces, and so on.

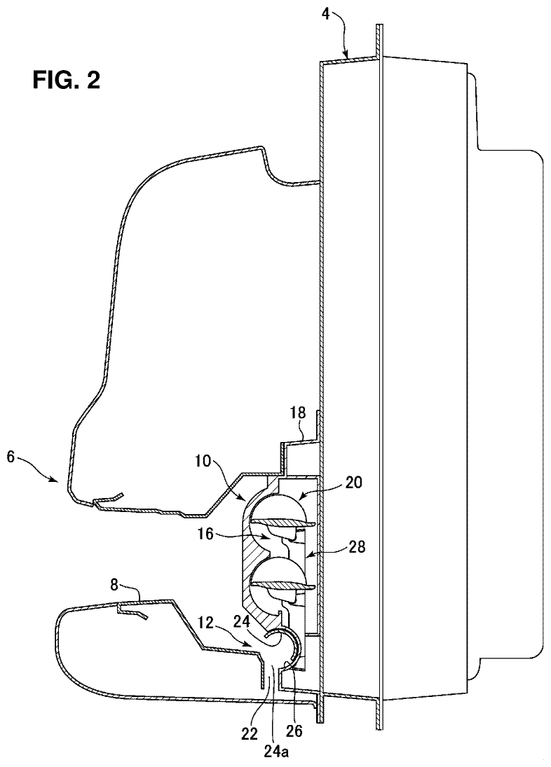

Next, a schematic structure and a layout of the grille shutter device 10 and the foreign-object removal device 12 will be described referring to FIGS. 2 and 3. FIG. 2 is a partially-sectional left-side view of the grille shutter device, the foreign-object removal device, and a front grille of the vehicle according to the embodiment of the present invention, showing an open state of the grille shutter device and the foreign-object removal device. FIG. 3 is a perspective view of the grille shutter device and the foreign-object removal device according to the present embodiment, when viewed from a vehicle front-left side, showing a closed state of these devices. As shown in FIGS. 2 and 3, the grille shutter device 10 comprises a rectangular-shaped grille shutter frame 18 which has a grille opening portion (first opening portion) 16 at its center and a grille shutter 20 which is provided in the opening portion 16 of the grille shutter frame 18.

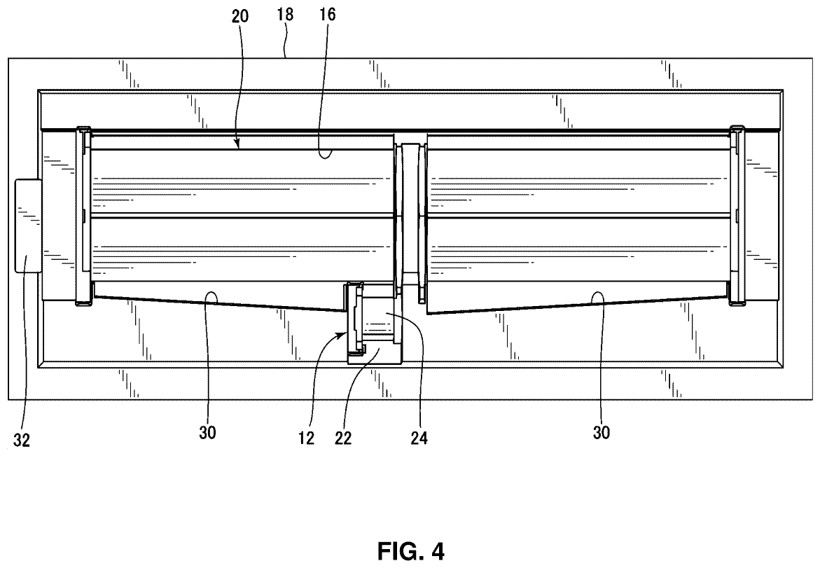

As shown in FIGS. 2 and 3, the grille shutter 20 is comprised of in total four wing-shaped members. The grille shutter 20 is driven by an actuator 32 (see FIG. 4), described later, and configured in the present embodiment such that a state of the grille opening portion 1 is changed between a closed state for mainly reducing the air resistance and an open state for introducing the traveling air to the radiator 4.

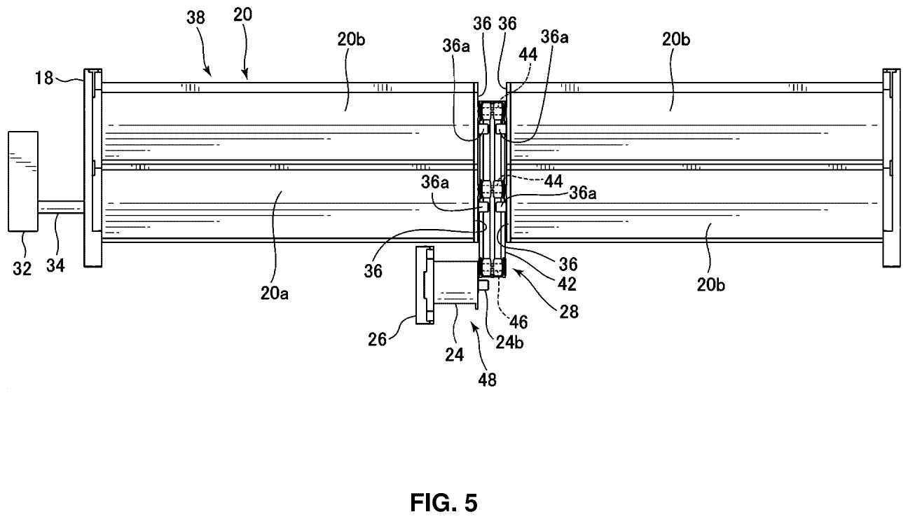

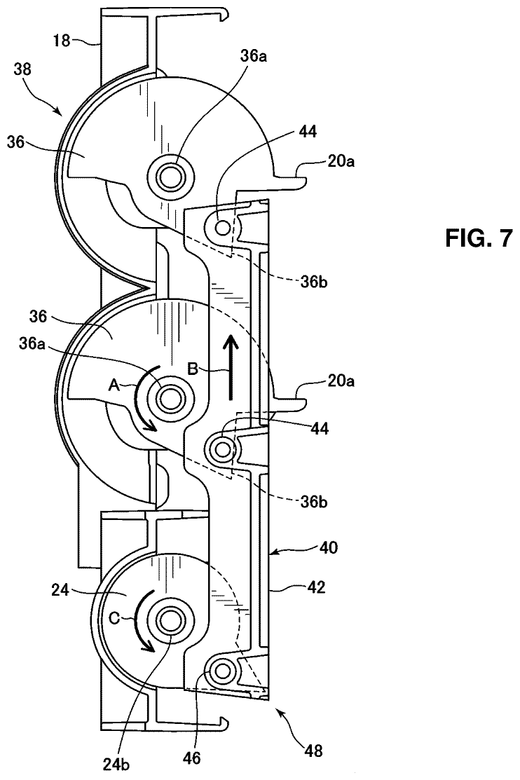

Further, as shown in FIGS. 2 and 3, the foreign-object removal device 12 is provided below the grille shutter 20. The foreign-object removal device 12 primarily comprises a foreign-object removal hole 22 which is formed at the grille shutter frame 18, a hole opening-closing valve 24 to open and close the foreign-object removal hole 22, and a support member 26 to rotatably support the hole opening-closing valve 24. Herein, the hole opening-closing valve 24 is pivotally supported by rotational axes which are positioned at both sides, in a vehicle width direction, thereof (a one-side rotational axis 24b is only illustrated in FIGS. 5 and 7). Further, the support member 26 partially supports both-end portions and an outer peripheral portion of the hole opening-closing valve 24.

As shown in FIGS. 2 and 3, the foreign-object removal hole 22 is formed at a lower portion of the grille shutter frame 18, more specifically at a lower side of four sides of the rectangular-shaped grille shutter frame 18. The foreign-object removal hole 22 is open to the vehicle lower side, so that the foreign objects, such as water or small stones, can be discharged and removed to the vehicle outside though the foreign-object removal hole 22.

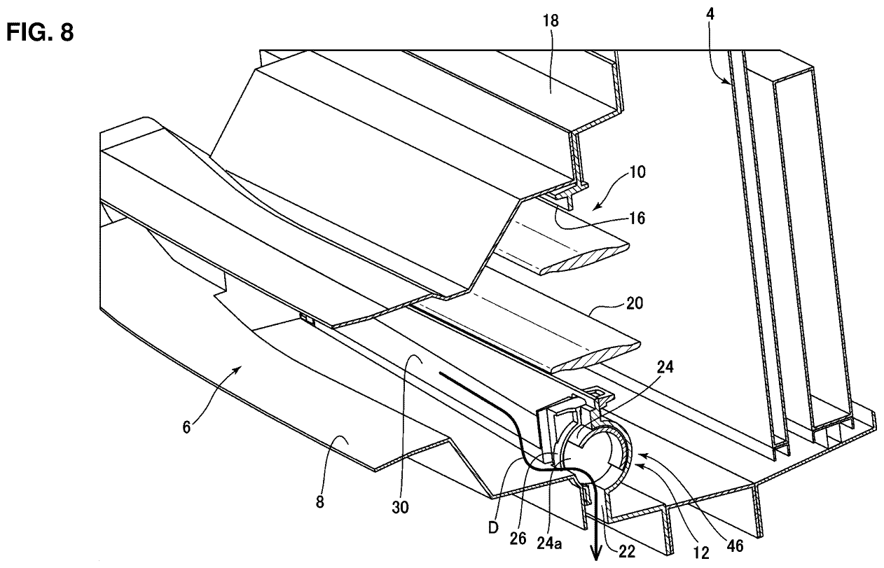

The hole opening-closing valve 24 is a semi-cylindrical shaped member having a C-shaped cross section where an opening 24a is formed, and rotates so as to have two states, a closed state of closing the foreign-object removal hole 22 for mainly reducing the air resistance and an open state of opening the foreign-object removal hole 22 for removing the foreign objects. That is, the opening 24a does not face the foreign-object removal hole 22 in the closed state (see FIGS. 3, 4 and 9), but the opening 24a faces the foreign-object removal hole 22 in the open state (see FIGS. 2 and 8).

The hole opening-closing valve 24 moves synchronously with opening-closing of the grille shutter 20 by means of a connecting device 28 (see FIGS. 5-7 and others), described later, so that the hole opening-closing valve 24 rotates such that it has the closed state when the grille shutter 20 is closed.

Next, the structure of the grille shutter device 10 and the layout of the foreign-object removal device 12 will be described referring to FIG. 4. FIG. 4 is an elevational view of the grille shutter device and the foreign-object removal device according to the present embodiment, when viewed from a vehicle front side. First, as shown in FIG. 4, the foreign-object removal device 12 is provided at a central portion, in the vehicle width direction, of a lower part of the grille shutter frame 18. Further, as shown in FIG. 4, the lower part of the grille shutter frame 18 has a pair of inclination portions 30, which are configured to be downward inclined from the right-and-left outside portions, in the vehicle width direction, thereof toward the foreign-object removal hole 22 and the hole opening-closing valve 24 which are provided at the central portion. In the present embodiment, the rainwater or the like flow down or the small stones or the like roll along the inclination portion 30, so that the foreign objects gather at the foreign-object removal device 12. Moreover, as shown in FIG. 4, an actuator 32 to drive the grille shutter 20 for opening and closing the grille shutter 20 is attached to the grille shutter frame 18.

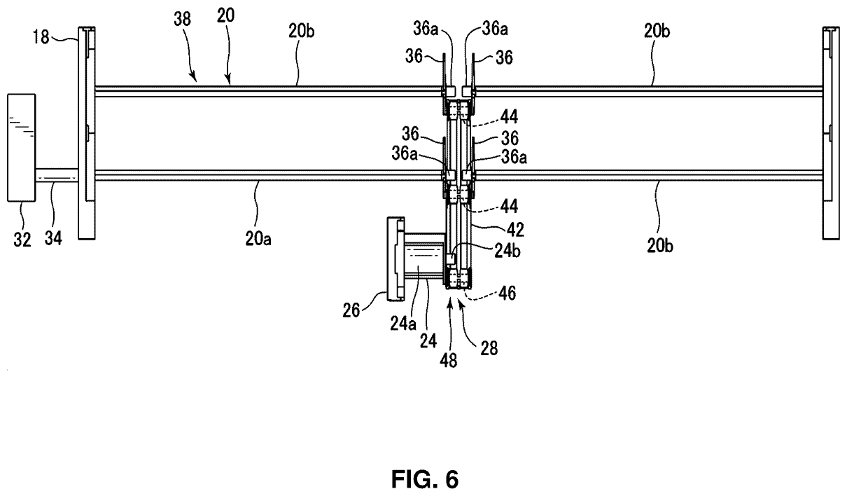

Subsequently, the respective structures of the grille shutter device 10 and the foreign-object removal device 12 which are driven by the above-described actuator 32 will be described referring to FIGS. 5 through 7. FIG. 5 is an elevational view explaining respective main parts of the grille shutter device and the foreign-object removal device according to the present embodiment, showing the closed state of these devices. FIG. 6 is an elevational view explaining the respective main parts of the grille shutter device and the foreign-object removal device according to the present embodiment, showing the open state of these devices. FIG. 7 is a side view explaining a schematic structure of a linkage device of the grille shutter device and the foreign-object removal device according to the present embodiment, when viewed from a vehicle left side.

First, as shown in FIGS. 5 and 6, the above-described actuator 32 drives the grille shutter 20 via a drive shaft 34 so that the grille shutter 20 can be opened and closed. In the present embodiment, the actuator 32 directly drives one of four wing-shaped members 20a of the grille shutter 20, and the rest of the wing-shaped members 20b are driven according to the moving of the grille shutter 20a.

The four wing-shaped members 20a, 20b are rotatably pivoted at the grille shutter frame 18 at outward-side end portions, in the vehicle width direction, thereof. Meanwhile, central-side end portions, in the vehicle width direction, thereof are fixed to shutter flaps 36, described later. In the present embodiment, the four wing-shaped members 20a, 20b of the grille shutter 20 rotate according to the rotation of the shutter flaps 36, so that the grille opening portion 16 is opened or closed.

As described above, the shutter flaps 36 are attached to the central-side end portions, in the vehicle width direction, of the four wing-shaped members 20a, 20b of the grille shutter 20. Herein, the shutter flaps 36 may be formed integrally with the four wing-shaped members 20a, 20b.

As shown in FIGS. 5 through 7, these shutter flaps 36 are roughly semicircular-shaped members and extend in a perpendicular direction to the wing-shaped members 20a, 20b (a direction on a surface including a vehicle vertical direction and a vehicle longitudinal direction). As shown in FIGS. 5 through 7, respective rotational axes 36a of the shutter flaps 36 are supported at the grille shutter frame 18 so that the shutter flaps 36 can rotate around the respective rotational axes (rotational centers) 36a, and the respective central-side end portions, in the vehicle width direction, of the wing-shaped members 20a, 20b are attached to the rotational axes 36a.

In the present embodiment, the wing-shaped members 20a, 20b of the grille shutter 20 and the shutter flaps 36 constitute a grille opening-closing device 38, and this grille opening-closing device 38 is driven by the above-described actuator 32.

As shown in FIG. 7, each of the shutter flaps 36 comprises a flap protrusion portion 36b which protrudes in a radial direction from the rotational center 36a, and a connection shaft 42 of a connection device 40 of the present embodiment is connected to the flap protrusion portion 36b. Herein, the connection device 40 of the present embodiment is a device to connect the grille shutter device 10 and the foreign-object removal device 12, which serves as a link mechanism by a mutual operation of the shutter flap 36, the flap projection portion 36b, the connection shaft 42, and connection pins 44, 46, described later. In the present embodiment, moving of the grille shutter device 10 and moving of the foreign-object removal device 12 are synchronized by means of the connection device 40.

Next, the structure of the connection device 40 will be described more specifically. As shown in FIG. 7, the respective flap protrusion portions 36b and the connection shaft 42 are connected at an upper-end portion and a middle portion of the connection shaft 42 via respective connection pins 44. The connection pins 44 are shown by a broken line in FIGS. 5 and 6. In the present embodiment, the connection pin 44 and the shutter flap 36 (the flap protrusion portion 36b) are formed integrally, and the connection pin 44 is rotatably supported at the connection shaft 42. Herein, the connection pin 44 may be configured to be separated from the shutter flap 36.

Meanwhile, as shown in FIG. 7, the connection shaft 42 and the hole opening-closing valve 24 are connected via the connection pin (the pin for a hole opening-closing device) 46 at a lower-end portion of the connection shaft 42. The connection pin 46 is shown by a broken line in FIGS. 5 and 6. In the present embodiment, the connection pin 46 is formed integrally with the hole opening-closing valve 24, and the connection pin 46 is rotatably supported at the connection shaft 42. Herein, the connection pin 46 may be configured to be separated from the hole opening-closing valve 24.

As shown in FIG. 7, the connection pin 46 is provided at a position which protrudes in the radial direction from the rotational axis 24b of the hole opening-closing valve 24, so that when the connection shaft 42 is moved, the hole opening-closing valve 24 is operated so as to open and close. Thus, in the present embodiment, the hole opening-closing device (the first opening opening-closing device) 48 to open and close the foreign-object removal hole 22 is constituted by the connection pin 46 connected to the connection shaft 42, the hole opening-closing valve 24, and the rotational axis 24b, and this device 48 moves synchronously with the grille shutter device 10. In the present embodiment, the hole opening-closing device 48 is driven by the above-described actuator 32.

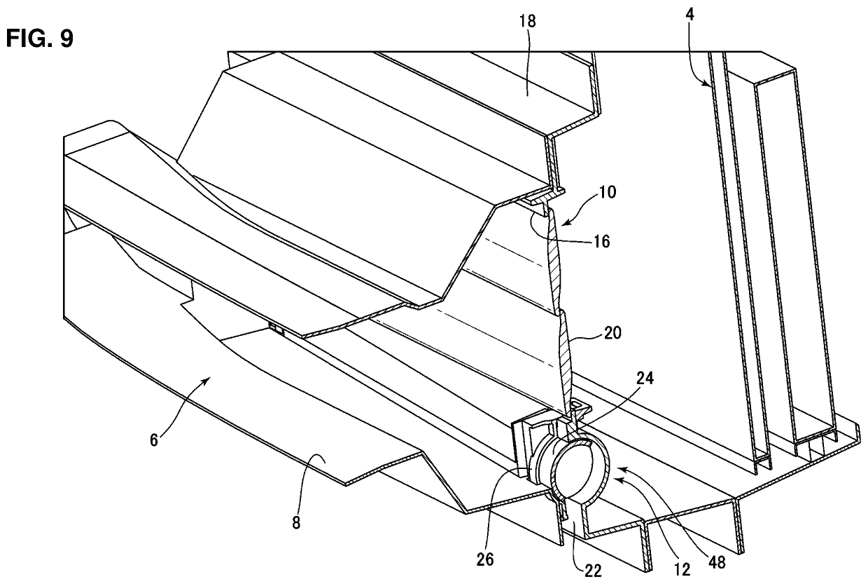

Subsequently, as shown in FIGS. 7 through 9, the respective moving of the grille shutter device 10, the connection device 28, and the foreign-object removal device 12 according to the operation of the actuator 32 will be described. FIG. 8 is a partially-sectional perspective view of the grille shutter device and the foreign-object removal device according to the present embodiment, when viewed from the vehicle front-left side, explaining functions of these devices in the open state. FIG. 9 is a partially-sectional perspective view of the grille shutter device and the foreign-object removal device according to the present embodiment, when viewed from the vehicle front-left side, explaining functions of these devices in the closed state. First, in FIG. 7, when the actuator 32 is operated to drive the wing-shaped member 20a of the grille shutter 20 in an opening direction shown by an arrow A, the connection shaft 42 moves in a direction shown by an arrow B and thereby the hole opening-closing valve 24 moves in a direction shown by an arrow C, so that the hole opening-closing valve 24 has an open state as shown in FIG. 8.

As shown in FIG. 8, the foreign objects, such as the small stones or the rainwater, which have flowed in the vehicle inside of the vehicle through the front grille 6 or the lower duct 8, gather at the foreign-object removal device 12 and then are discharged and removed to the vehicle outside out of the opening 24a of the hole opening-closing valve 24 and the foreign-object removal hole 22 by way of the inclination portion 30 of the grille shutter frame 18 (and part of the lower duct 8 in the present embodiment) as shown by an arrow D. Consequently, the foreign objects are removed. Herein, the grille shutter frame 18 may be configured such that the foreign objects moving on the inclination portion 30 directly flow into the foreign-object removal hole 22.

In this state, as shown in FIG. 8, since the grille shutter 20 is in the closed state, the cooling effect by means of the radiator 4 can be improved by introducing the traveling air to the radiator 4.

Meanwhile, as understandable from FIG. 7, when the actuator 32 is operated to drive the wing-shaped grille shutter 20a of the grille shutter 20 in its closed direction (opposite to the direction shown by the arrow A), the connection shaft 42 moves in an opposite direction to the arrow B direction and thereby the hole opening-closing valve 24 rotates in an opposite direction to the arrow C direction, so that the hole opening-closing valve 24 has a closed state as shown in FIG. 9.

In this state, as shown in FIG. 9, since both the grille shutter 20 and the foreign-object removal hole 22 are in the closed state, the traveling resistance as the air resistance is so reduced that the fuel economy can be improved.

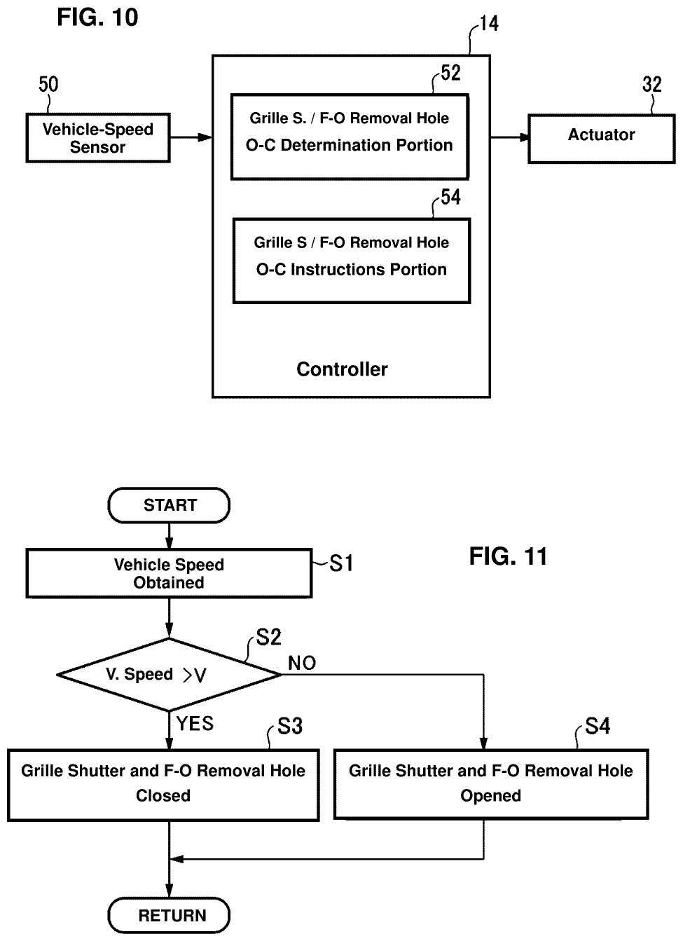

Next, the control contents of the vehicle 1 which are executed by the controller 14 according to the present embodiment will be described referring to FIGS. 10 and 11. In FIG. 11, each control step is denoted by reference character S. First, as shown in FIG. 10, a vehicle-speed sensor 50 to detect a vehicle speed is coupled to the controller 14, and a signal of the vehicle speed detected by the vehicle-speed sensor 50 is inputted to the controller 14. Meanwhile, the actuator 32 is coupled to the controller 14, and the controller 14 is configured to control the operation of the actuator 32 based on the vehicle speed.

More specifically, the controller 14 comprises a grille-shutter/foreign-object-hole opening-closing determination portion 52 and a grille-shutter/foreign-object-hole opening-closing instructions portion 54. Herein, the grille-shutter/foreign-object-hole opening-closing determination portion 52 is configured to determine, based on the vehicle speed detected by the vehicle-speed sensor 50, whether the grille opening portion 16 and the foreign-object removal hole 22 are to be opened or closed. Meanwhile, the grille-shutter/foreign-object-hole opening-closing instructions portion 54 is configured to supply to the actuator 32 an instructions signal to make the grille opening portion 16 and the foreign-object removal hole 22 be opened or closed based on the determination by the determination portion 52.

As shown in FIG. 11, the controller 14 obtains the vehicle speed based on the signal from the vehicle-speed sensor 50 in step S1. In the next step S2, it is determined by the determination portion 52 whether the vehicle speed obtained in the step S1 exceeds a specified vehicle speed V (20 km/h, in the present embodiment) or not. Herein, the determination portion 52 of the present embodiment is configured to determine that the grille opening portion 16 and the foreign-object removal hole 22 are to be closed when the vehicle speed exceeds the above-described vehicle speed V. Meanwhile, the determination portion 52 of the present embodiment is configured to determine that the grille opening portion 16 and the foreign-object removal hole 22 are to be opened when the vehicle speed does not exceed the vehicle speed V.

Next, when it is determined in the step S2 that the vehicle speed exceeds the vehicle speed V and therefore the grille opening portion 16 and the foreign-object removal hole 22 are to be closed (YES, in the step S2), the control sequence proceeds to step S3, where the instructions portion 54 supplies to the actuator 32 the instructions signal to make the grille opening portion 16 and the foreign-object removal hole 22 be closed. This processing of the step S3 produces the state shown in FIG. 9 where the grille opening portion 16 and the foreign-object removal hole 22 are closed.

Meanwhile, when it is determined in the step S2 that the vehicle speed does not exceed the vehicle speed V and therefore the grille opening portion 16 and the foreign-object removal hole 22 are to be opened (NO, in the step S2), the control sequence proceeds to step S4, where the instructions portion 54 supplies to the actuator 32 the instructions signal to make the grille opening portion 16 and the foreign-object removal hole 22 be opened. This processing of the step S4 produces the state shown in FIG. 8 where the grille opening portion 16 and the foreign-object removal hole 22 are opened.

Herein, more specifically, the opening-closing of the grille opening portion 16 and the foreign-object removal hole 22 in the steps S3 and S4 are conducted by both the operation of the grille shutter 20 which is caused by the grille opening-closing device 38 driven by the actuator 32 and the operation of the hole opening-closing valve 24 which is caused by the hole opening-closing device 48 according to the respective operations of the grille shutter 20 and the connection device 28.

The threshold V is set at 20 km/h in the present embodiment because it may be considered that the influence of the traveling resistance (air resistance) is relatively small in a low vehicle-speed range (less than 20 km/h) but the influence of the traveling resistance (air resistance) is relatively large in a high vehicle-speed range (20 km/h and more). However, this vehicle-speed threshold V may be modified appropriately according to various factors, such as vehicle shape or vehicle specifications.

Further, while the above-described embodiment exemplifies the electric automobile as the vehicle 1, the present invention is applicable to any type of vehicles provided with an internal combustion engine, including a hybrid vehicle.

Next, the effects (operations) of the vehicle 1 of the present embodiment will be described.

The vehicle 1 of the present embodiment comprises the heat exchanger 4 provided at the front part of the vehicle 1, the first opening portion (grille opening portion 16) provided in front of the heat exchanger 4 and to introduce the traveling air therethrough to the vehicle rear side, and the second opening portion (foreign-object removal hole 22) provided below the first opening portion and to discharge and remove the foreign objects therethrough to the vehicle outside, wherein the opening-closing device (the hole opening-closing valve 24, the hole opening-closing device 48) to open and close the second opening portion is provided at the second opening portion.

According to the present embodiment, since the second opening portion (22) for discharging and removing the foreign objects therethrough to the vehicle outside is provided in front of the heat exchanger 4 and below the first opening portion (16) and also the opening-closing device (24, 48) to open and close the second opening portion is provided, by opening or closing the second opening portion according to the degree of the traveling resistance (particularly, the air resistance), the foreign objects can be removed properly, suppressing the turbulence of the traveling air and thereby reducing the traveling resistance. That is, the traveling resistance can be reduced properly by closing the second opening portion when the traveling resistance of the vehicle is large (e.g., at the high vehicle-speed). Meanwhile, when the traveling resistance is small (e.g., at the low vehicle-speed), the foreign objects can be removed properly by opening the second opening portion.

Further, according to the present embodiment, since the frame member 18 to form the first opening portion (grille opening portion 16) is provided, the second opening portion (foreign-object removal hole 22) is formed at the lower part of the frame member 18, and the lower part of the frame member 18 has the inclination portion 30 which is configured to be downward inclined toward the second opening portion in the elevational view, the foreign objects tend to gather at the second opening portion, so that the foreign objects which have come in from the vehicle front side, for example, can be removed more effectively.

Moreover, according to the present embodiment, since the second opening portion (foreign-object removal hole 22) and the opening-closing device (the hole opening-closing valve 24, the hole opening-closing device 48) constitute the foreign-object removal device 12, which is provided at the central portion of the lower part of the frame member 18 in the elevational view, the foreign objects can be removed more effectively by providing the foreign-object removal device 12 at the lateral-symmetrical position.

Also, according in the present embodiment, the opening-closing device (the grille shutter 20, the grille opening-closing device 38) to open and close the first opening portion (grille opening portion 16) is provided at this first opening portion, and the both opening-closing devices (20, 38, 24, 48) are linked by the linkage member 42 such that these both devices are movable synchronously.

According to this structure, deterioration of the traveling resistance due to the driving delay can be prevented. That is, when the first opening portion is closed by the opening-closing device for the first opening portion and thereby the traveling resistance (air resistance) caused by the traveling air flowing in the heat exchanger is reduced, the second opening portion is closed at the same time by driving the opening-closing device for the second opening portion concurrently with the function of the linkage member 42, so that the traveling resistance (air resistance) caused by the traveling air flowing in the second opening portion can be reduced.

Further, in the present embodiment, the first opening portion is the grille opening portion 16 which is provided on the front-face side of the heat exchanger and introduces the traveling air therethrough to the heat exchanger, the opening-closing device for the first opening portion is the grille-shutter device 10 comprising the grille shutter 20 operative to open and close the grille opening portion 16, the actuator 32 to drive the grille shutter is connected to the grille-shutter device, the opening-closing device for the second opening portion comprises the opening-closing valve 24 operative to open and close the second opening portion, and the linkage member 42 interconnects the grille shutter 20 and the opening-closing valve 24 such that when the grille shutter is closed by the actuator 32, the opening-closing valve 24 is closed.

According to this structure, when the first opening portion (grille opening portion 16) is closed by driving the grille shutter 20 by means of the actuator 32 for the reduction of the traveling resistance (air resistance) due to the traveling air flowing in the heat exchanger, the traveling resistance (air resistance) due to the traveling air flowing in the second opening portion can be reduced by closing the opening-closing valve 24 of the second opening portion (foreign-object removal hole 22) concurrently with the function of the linkage member 42. Accordingly, the first opening portion (grille opening portion) and the second opening portions are made in the closed state at the same time, thereby reducing the vehicle resistance more securely.

Moreover, in the present embodiment, the vehicle comprises the opening-closing device (the grille shutter 20, the grille opening-closing device 38) to open and close the first opening portion (grille opening portion 16), the actuator 32 to drive the opening-closing device (the grille shutter 20, the grille opening-closing device 38) for the first opening portion (grille opening portion 16) and the opening-closing device (the hole opening-closing valve 24, the hole opening-closing device 48) for the second opening portion (foreign-object removal hole 22), the vehicle-speed sensor 50 to detect the speed of the vehicle 1, and the control device (controller 14) to control the actuator 32 according to the vehicle speed detected by the vehicle-speed sensor, wherein the control device is configured such that when the detected vehicle speed is the specified speed (V) or more, both the opening-closing devices are driven to close both the opening portions, and when the detected vehicle speed is less than the specified speed (V), both the opening-closing devices are driven to open both the opening portions.

According to this structure, when the detected vehicle speed is the specified speed or more and therefore it is considered that the traveling resistance is relatively large, the actuator 32 is driven such that the first opening portion (grille opening portion 16) and the second opening portion (foreign-object removal hole 22) are closed together, thereby reducing the traveling resistance effectively. Meanwhile, when the detected vehicle speed is less than the specified speed and thereby it is considered that the traveling resistance is relatively small, the actuator 32 is driven such that the first opening portion and the second opening portion are opened together, thereby removing the foreign object effectively.

Also, according to the present embodiment, since the vehicle 1 comprises the linkage member 42 to interconnect both the opening-closing devices (the grille shutter 20, the grille opening-closing device 38, the hole opening-closing valve 24, the hole opening-closing device 48) such that the both devices are movable synchronously, wherein the actuator 32 drives the opening-closing device (the grille shutter 20, the grille opening-closing device 38) for the first opening portion, and the opening-closing device (the hole opening-closing valve 24, the hole opening-closing device 48) for the second opening portion is driven synchronously with the opening-closing device for the first opening portion driven by the actuator 32 by means of the linkage member 42, the deterioration of the traveling resistance due to the driving delay can be prevented. That is, when the first opening portion is closed by the actuator 32 driving the opening-closing device for the first opening portion and thereby the traveling resistance (air resistance) caused by the traveling air flowing in the heat exchanger is reduced, the opening-closing device for the second opening portion is driven at the same time by the function of the linkage member and thereby the second opening is closed at the same time, so that the traveling resistance (air resistance) due to the traveling air flowing in the second opening portion can be reduced.

Further, in the present embodiment, the first opening portion is the grille opening portion 16 which is provided on the front-face side of the heat exchanger 4 and introduces the traveling air therethrough to the heat exchanger, the opening-closing device for the first opening portion is the grille-shutter device 10 comprising the grille shutter 20 operative to open and close the grille opening portion, the actuator 32 drives the grille shutter 20 of the grille shutter device, and the opening-closing device for the second opening portion is driven according to opening and closing of the grille shutter 20 such that when the grille shutter is closed, the opening-closing device for the second opening portion is closed, and when the grille shutter is opened, the opening-closing device for the second opening portion is opened.

According to this structure, when the first opening portion (grille opening portion) is closed by driving the grille shutter by means of the actuator for the reduction of the traveling resistance (air resistance) due to the traveling air flowing in the heat exchanger, the traveling resistance (air resistance) due to the traveling air flowing in the second opening portion can be reduced by closing the opening-closing valve of the second opening portion concurrently. Accordingly, the first opening portion (grille opening portion) and the second opening portions are made in the closed state at the same time, thereby reducing the vehicle resistance more securely.

Additionally, in the present embodiment, the opening-closing device for the second opening portion comprises the opening-closing valve 24 operative to open and close the second opening portion (foreign-object removal hole 22), and the vehicle 1 comprises the linkage member 42 to interconnect the grille shutter 20 and the opening-closing valve 24 such that when the grille shutter 20 is closed by the actuator 32, the opening-closing of the opening-closing valve 24 is synchronized with the opening-closing of the grille shutter 20.

According to this structure, when the first opening portion (grille opening portion 16) is closed by driving the grille shutter 20 by means of the actuator 32 for the reduction of the traveling resistance (air resistance) due to the traveling air flowing in the heat exchanger, the traveling resistance (air resistance) due to the traveling air flowing in the second opening portion (foreign-object removal hole 22) can be reduced by closing the opening-closing valve 24 of the second opening portion concurrently with the function of the linkage member 42. Accordingly, the first opening portion (grille opening portion) and the second opening portions are made in the closed state at the same time, thereby reducing the vehicle resistance more securely.

What is claimed is:

1. A vehicle, comprising:
a heat exchanger provided at a front part of the vehicle;
a first opening portion provided in front of the heat exchanger and to introduce traveling air therethrough to a vehicle rear side; and
a second opening portion provided below the first opening portion and to discharge and remove a foreign object therethrough to a vehicle outside,
wherein an opening-closing device to open and close said second opening portion is provided at the second opening portion.

2. The vehicle of claim 1, wherein a frame member to form said first opening portion is provided, said second opening portion is formed at a lower part of said frame member, and said lower part of the frame member has an inclination portion which is configured to be downward inclined toward the second opening portion in an elevational view.

3. The vehicle of claim 2, wherein said second opening portion and said opening-closing device constitute a foreign-object removal device, which is provided at a central portion of said lower part of the frame member in the elevational view.

4. The vehicle of claim 1, wherein another opening-closing device to open and close said first opening portion is provided at the first opening portion, and said both opening-closing devices are linked by a linkage member such that the both devices are movable synchronously.

5. The vehicle of claim 2, wherein another opening-closing device to open and close said first opening portion is provided at the first opening portion, and said both opening-closing devices are linked by a linkage member such that the both devices are movable synchronously.

6. The vehicle of claim 3, wherein another opening-closing device to open and close said first opening portion is provided at the first opening portion, and said both opening-closing devices are linked by a linkage member such that the both devices are movable synchronously.

7. The vehicle of claim 4, wherein said first opening portion is a grille opening portion which is provided on a front-face side of said heat exchanger and introduces the traveling air therethrough to the heat exchanger, said opening-closing device for the first opening portion is a grille-shutter device comprising a grille shutter operative to open and close said grille opening portion, an actuator to drive said grille shutter is connected to said grille-shutter device, said opening-closing device for the second opening portion comprises an opening-closing valve operative to open and close said second opening portion, and said linkage member interconnects said grille shutter and said opening-closing valve such that when the grille shutter is closed by said actuator, the opening-closing valve is closed.

8. The vehicle of claim 1, further comprising another opening-closing device to open and close said first opening portion, an actuator to drive said opening-closing device for the first opening portion and said opening-closing device for the second opening portion, a vehicle-speed sensor to detect a speed of the vehicle, and a control device to control said actuator according to the vehicle speed detected by the vehicle-speed sensor,
wherein said control device is configured such that when said detected vehicle speed is a specified speed or more, both the opening-closing devices are driven to close both the opening portions, and when the detected vehicle speed is less than the specified speed, both the opening-closing devices are driven to open both the opening portions.

9. The vehicle of claim 2, further comprising another opening-closing device to open and close said first opening portion, an actuator to drive said opening-closing device for the first opening portion and said opening-closing device for the second opening portion, a vehicle-speed sensor to detect a speed of the vehicle, and a control device to control said actuator according to the vehicle speed detected by the vehicle-speed sensor,
wherein said control device is configured such that when said detected vehicle speed is a specified speed or more, both the opening-closing devices are driven to close both the opening portions, and when the detected vehicle speed is less than the specified speed, both the opening-closing devices are driven to open both the opening portions.

10. The vehicle of claim 3, further comprising another opening-closing device to open and close said first opening portion, an actuator to drive said opening-closing device for the first opening portion and said opening-closing device for the second opening portion, a vehicle-speed sensor to detect a speed of the vehicle, and a control device to control said actuator according to the vehicle speed detected by the vehicle-speed sensor,
wherein said control device is configured such that when said detected vehicle speed is a specified speed or more, both the opening-closing devices are driven to close both the opening portions, and when the detected vehicle speed is less than the specified speed, both the opening-closing devices are driven to open both the opening portions.

11. The vehicle of claim 6, further comprising a linkage member to interconnect both said opening-closing devices such that the both devices are movable synchronously, wherein said actuator drives the opening-closing device for the first opening portion, and the opening-closing device for the second opening portion is driven synchronously with the opening-closing device for the first opening portion driven by the actuator by means of said linkage member.

12. The vehicle of claim 8, wherein said first opening portion is a grille opening portion which is provided on a front-face side of said heat exchanger and introduces the traveling air therethrough to the heat exchanger, said opening-closing device for the first opening portion is a grille-shutter device comprising a grille shutter operative to open and close said grille opening portion, said actuator drives said grille shutter of the grille shutter device, and said opening-closing device for the second opening portion is driven according to opening and closing of the grille shutter such that when the grille shutter is closed, the opening-closing device for the second opening portion is closed, and when the grille shutter is opened, the opening-closing device for the second opening portion is opened.

13. The vehicle of claim 12, wherein said opening-closing device for the second opening portion comprises an opening-closing valve operative to open and close said second opening portion, and the vehicle further comprises a linkage member to interconnect said grille shutter and said opening-closing valve such that when the grille shutter is closed by said actuator, opening-closing of the opening-closing valve is synchronized with opening-closing of the grille shutter.
